(19) United States
(12) Patent Application Publication
(10) Pub. No.: US 2020/0269690 A1
(43) Pub. Date: Aug. 27, 2020

(54) DISPLAY CONTROL APPARATUS AND METHOD OF DISPLAY CONTROL

(71) Applicant: Mitsubishi Electric Corporation, Tokyo (JP)

(72) Inventor: Norihiro NAITO, Tokyo (JP)

(73) Assignee: Mitsubishi Electric Corporation, Tokyo (JP)

(21) Appl. No.: 16/647,416

(22) PCT Filed: Nov. 7, 2017
(86) PCT No.: PCT/JP2017/040018

§ 371 Date: Mar. 13, 2020

(51) Int. Cl. B60K 35/00; G02B 27/01

(52) U.S. Cl. CPC B60K 35/00; G02B 27/01; B60K 2370/52; B60K 2370/1529; B60K 2370/176; B60K 2370/21

(57) ABSTRACT

An object of the present invention is to provide a display control apparatus and a method of display control capable of improving the visibility of information. According to the present invention, a display control apparatus includes a camera image acquisition unit configured to acquire a camera image that is an image captured by a camera, a composition unit configured to generate a composite image by composing one area among a plurality of areas obtained by dividing the camera image acquired by the camera image acquisition unit with a predetermined icon image, an index calculation unit configured to calculate an index representing ease of recognition of the icon image in the composite image generated by the composition unit, and a display position determination unit configured to determine a display position of the icon image based on the index calculated by the index calculation unit.

### TECHNICAL FIELD

The present invention relates to a display control apparatus and a method of display control for controlling a display position of an icon image composed with a camera image.

### BACKGROUND ART

As a device for providing a driver of a vehicle such as an automobile with information, there has been a display provided in an instrument panel or a head-up display (HUD) provided in front of the driver's line of sight. In particular, the HUD has been drawing attention in that the driver can obtain information without greatly moving the driver's line of sight.

The HUD includes a combiner that is a translucent transmission plate and a projector that projects information onto the combiner. The projector projects, for example, an icon image indicating a warning to the driver on the combiner in accordance with instruction from the display control apparatus. Thus, the driver can see the icon image displayed on the combiner without greatly moving the line of sight from the scenery over the combiner in front of the vehicle.

When the driver looks at the combiner, the icon image displayed on the combiner is superimposed on the scenery over the combiner in front of the vehicle. The scenery over the combiner in front of the vehicle changes with the movement of the vehicle. Therefore, the icon image may be buried in the scenery depending on the color of the scenery in front of the vehicle, and the driver may have a difficulty in seeing the icon image. As a countermeasure for such a problem, conventionally, a technique has been disclosed in which, the color of the information displayed on the combiner or the color of the display surface of the combiner is changed or the display position of the information displayed on the combiner is changed according to the state of the scenery in front of the vehicle (see, Patent Document 1).

### PRIOR ART DOCUMENTS

### Patent Documents

[Patent Document 1] Japanese Patent Application Laid-Open No. 10-311732

### SUMMARY

### Problem to be Solved by the Invention

In Patent Document 1, the color of the scenery in front of the vehicle is estimated using an estimation algorithm based on the map data having information on the scenery in front of the vehicle and the data obtained from the camera capturing the scenery in front of the vehicle. And the color of information displayed on the combiner or the color of the display surface of the combiner is changed, in accordance with the color of the scenery. In Patent Document 1, although the estimation algorithm is not mentioned in detail, it is estimated that a method in which luminance of information is changed based on the luminance of the background using the color complementary to the color of the scenery in front of the vehicle obtained from the camera to make the contrast between the background and the information sharp, is employed.

However, such a method does not take what things are hard to see for a human into account; therefore, the displayed information may be glaring or the color of the information may be blurred, making the display of information possibly difficult to see. Further, in Patent Document 1, when an object significant for driving such as an oncoming vehicle, an obstacle, a traffic light, or a sign is present in front of the vehicle, the information display position is set so as not to be superimposed on the object. However, the information is not always easy to see at the changed display position. Thus, in Patent Document 1, it cannot be said that the visibility of information is necessarily good.

The present invention has been made to solve such a problem, and an object thereof is to provide a display control apparatus and a method of display control capable of improving the visibility of information.

### Means to Solve the Problem

In order to solve the above problems, according to the present invention, a display control apparatus includes a camera image acquisition unit configured to acquire a camera image that is an image captured by a camera, a composition unit configured to generate a composite image by composing one area among a plurality of areas obtained by dividing the camera image acquired by the camera image acquisition unit with a predetermined icon image, an index calculation unit configured to calculate an index representing ease of recognition of the icon image in the composite image generated by the composition unit, and a display position determination unit configured to determine a display position of the icon image based on the index calculated by the index calculation unit.

The method of display control according to the present invention includes acquiring a camera image that is an image captured by the camera, generating a composite image by composing a specific area obtained by dividing the acquired camera image with a predetermined icon image, calculating an index representing the ease of recognizing the icon image in the generated composite image, and determining a display position of the icon image based on the calculated index.

According to the present invention, a display control apparatus includes a camera image acquisition unit configured to acquire a camera image that is an image captured by a camera, a composition unit configured to generate a composite image by composing one area among a plurality of areas obtained by dividing the camera image acquired by the camera image acquisition unit with a predetermined icon image, an index calculation unit configured to calculate an index representing ease of recognition of the icon image in the composite image generated by the composition unit, and a display position determination unit configured to determine a display position of the icon image based on the index calculated by the index calculation unit. Therefore the visibility of information can be improved.

The method of display control includes acquiring a camera image that is an image captured by the camera, generating a composite image by composing a specific area obtained by dividing the acquired camera image with a predetermined icon image, calculating an index representing the ease of recognizing the icon image in the generated composite image, and determining a display position of the icon image based on the calculated index. Therefore the visibility of information can be improved.

The explicit purpose, feature, phase, and advantage of the present invention will be described in detail hereunder with attached drawings.

### BRIEF DESCRIPTION OF DRAWINGS

FIG. 1 is a diagram illustrating an example of an overall configuration including a display control apparatus according to Embodiment of the present invention.

FIG. 2 is a block diagram illustrating an example of a configuration of the display control apparatus according to Embodiment of the present invention.

FIG. 3 is a block diagram illustrating an example of a configuration of the display control apparatus according to Embodiment of the present invention.

FIG. 4 is a block diagram illustrating an example of a hardware configuration of the display control apparatus according to Embodiment of the present invention.

FIG. 5 is a flowchart illustrating an example of operation of the display control apparatus according to Embodiment of the present invention.

FIG. 6 is a flowchart illustrating an example of the operation of the display control apparatus according to Embodiment of the present invention.

FIG. 7 is a diagram illustrating an example of a camera image according to Embodiment of the present invention.

FIG. 8 is a diagram illustrating an example of division of the camera image according to Embodiment of the present invention.

FIG. 9 is a diagram illustrating an example of a composite image according to Embodiment of the present invention.

FIG. 10 is a diagram illustrating an example of a display position of the icon image according to Embodiment of the present invention.

FIG. 11 is a diagram illustrating an example of display of the icon image according to Embodiment of the present invention.

FIG. 12 is a diagram illustrating an example of a camera image according to Embodiment of the present invention.

FIG. 13 is a diagram illustrating an example of a change in the display position of the icon image according to Embodiment of the present invention.

FIG. 14 is a diagram illustrating an example of the display of the icon image according to Embodiment of the present invention.

FIG. 15 is a diagram illustrating an example of an order of changing in a display position of the icon image according to Embodiment of the present invention.

FIG. 16 is a block diagram illustrating an example of a display control system according to Embodiment of the present invention.

### DESCRIPTION OF EMBODIMENT

Embodiment of the present invention will be described below with reference to the drawings.

### Embodiment

<Configuration>

FIG. 1 is a diagram illustrating an example of an overall configuration including a display control apparatus according to Embodiment of the present invention.

As illustrated in FIG. 1, a combiner 3 is provided in a place at which the line of sight of the driver 5 is not required to be moved greatly. A projector 2 is provided in a vehicle, and projects an icon image that is information, on the combiner 3. Here, the icon images are images warning to the driver while driving along the route from the current position to the destination, and such icon images include an arrow icon image that indicates which direction to proceed at the intersection, an icon image that indicates that there are many people in the current driving area, and an icon image indicates information obtained from sensors installed in the vehicle such as the remaining amount of gasoline.

A display control apparatus 1 is provided in the vehicle and controls the projector 2 in order to display an icon image on the combiner 3. A navigation device 4 is provided in the vehicle, and requests the display control apparatus 1 to display an icon image on the combiner 3.

A camera 6 is provided inside a roof 8 of the vehicle and near the head of the driver 5 to capture an image including the entirety of the combiner 3 and an image of the same landscape as that seen ahead of the line of sight of the driver 5, or an image including the entirety of the combiner 3 and an image of the landscape similar thereto. Note that the camera 6 may be provided at any position as long as the camera 6 can capture an image including the entire combiner 3, such as the headrest of the seat where the driver 5 sits, and an image of the same scenery as the scenery seen from the line of sight of the driver 5, or an image of the landscape similar thereto.

The driver 5 drives while looking at the scenery ahead over the windshield 7 of the vehicle. Thus, the driver can see an icon image displayed on the combiner 3 without greatly moving the line of sight from the scenery over the combiner 3 in front of the vehicle.

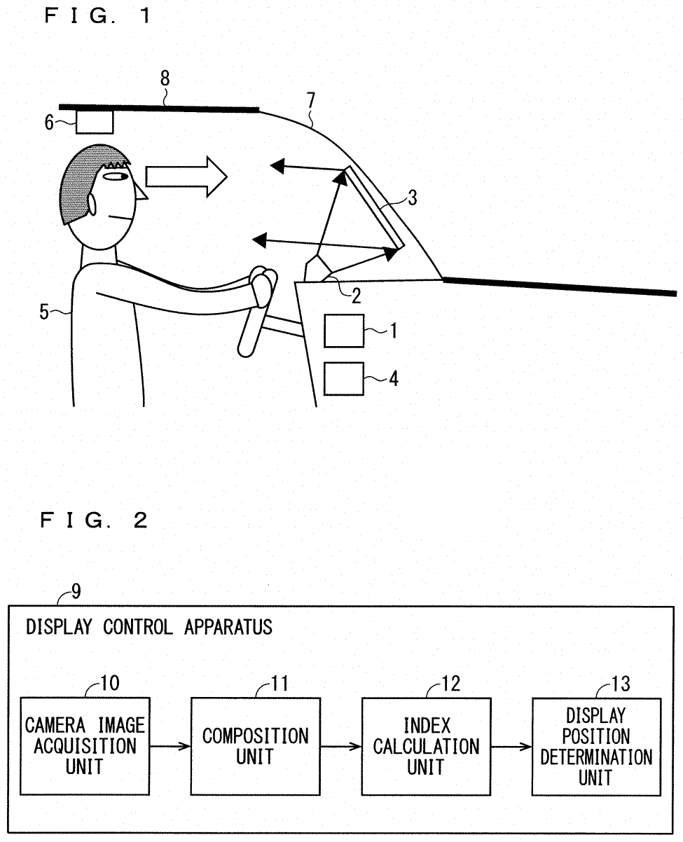

FIG. 2 is a block diagram illustrating an example of a configuration of the display control apparatus 9. Note that FIG. 2 illustrates a configuration with minimum requirements to configure a display control apparatus according to Embodiment. Further, the display control apparatus 9 corresponds to the display control apparatus 1 illustrated in FIG. 1.

As illustrated in FIG. 2, the display control apparatus 9 includes a camera image acquisition unit 10, a composition unit 11, an index calculation unit 12, and a display position determination unit 13. The camera image acquisition unit 10 acquires a camera image that is an image captured by the camera 6. The composition unit 11 composes one area among a plurality of areas obtained by dividing the camera image acquired by the camera image acquisition unit 10 with a predetermined icon image to generate a composite image.

The index calculation unit 12 calculates an index representing the ease of recognizing an icon image in the composite image generated by the composition unit 11. The display position determination unit 13 determines the display position of the icon image based on the index calculated by the index calculation unit 12.

Next, another configuration of the display control apparatus including the display control apparatus 9 illustrated in FIG. 2 will be described.

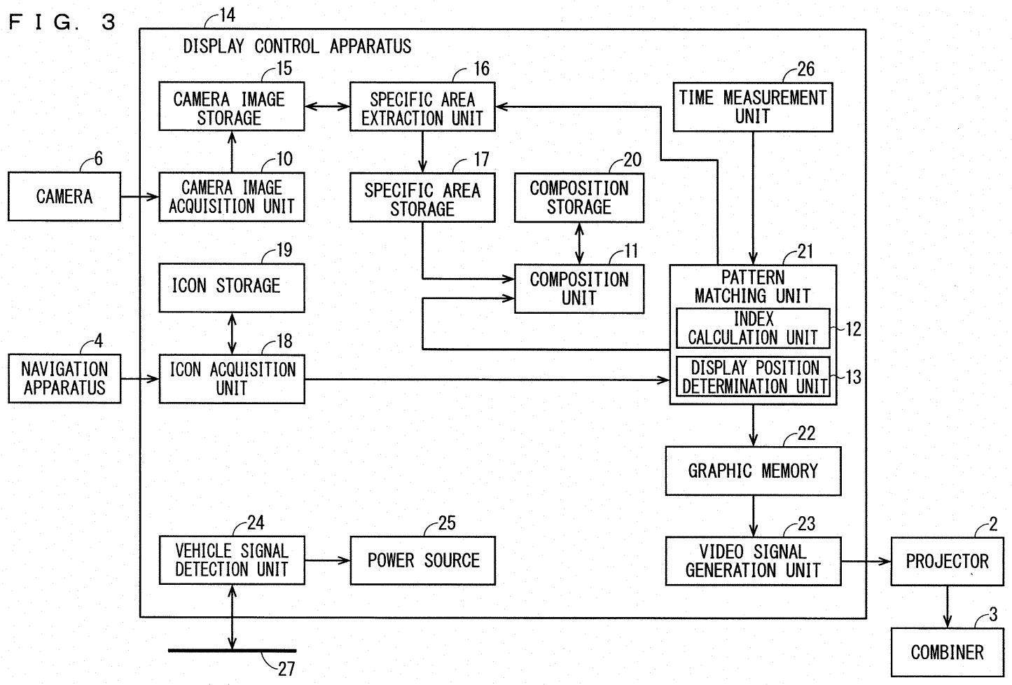

FIG. 3 is a block diagram illustrating an example of a configuration of the display control apparatus 14 according to another configuration. Note that, the display control apparatus 14 corresponds to the display control apparatus 1 illustrated in FIG. 1.

As illustrated in FIG. 3, the display control apparatus 14 includes a camera image acquisition unit 10, a composition unit 11, a camera image storage 15, a specific area extraction unit 16, a specific area storage 17, an icon acquisition unit 18, an icon storage 19, a composition storage 20, a pattern matching unit 21, a graphic memory 22, a video signal generation unit 23, a vehicle signal detection unit 24, a power source 25, and a time measurement unit 26.

The camera image acquisition unit 10 acquires a camera image captured by the camera 6. The camera image includes the scenery of the entire combiner 3 and the scenery over the combiner 3 in front of the vehicle. The camera image acquisition unit 10 stores the acquired camera image in the camera image storage 15.

The specific area extraction unit 16 divides the camera image stored in the camera image storage 15 into a plurality of areas, and extracts a specific area that is one of the plurality of divided areas. The specific area extraction unit 16 stores the extracted specific area in the specific area storage 17.

When the icon acquisition unit 18 acquires a request for displaying the icon image on the combiner 3 from the navigation device 4, the icon acquisition unit 18 acquires the icon image responding to the request from the icon storage 19. The icon acquisition unit 18 outputs the icon image acquired from the icon storage 19 to the pattern matching unit 21. The icon storage 19 stores various icon images.

The composition unit 11 composes the specific area stored in the specific area storage 17 with the icon image received from the pattern matching unit 21 in the composition storage 20. The composition unit 11 outputs the composite image obtained by composing the specific area with the icon image to the pattern matching unit 21.

The pattern matching unit 21 includes an index calculation unit 12 and a display position determination unit 13, and performs pattern matching of icon images included in the composite image. The index calculation unit 12 calculates an index representing the ease of recognizing an icon image in the composite image generated by the composition unit 11.

For example, the index calculation unit 12 extracts the data of the composite image for the data size of the icon image acquired from the icon acquisition unit 18, and calculates the correlating value of the extracted composite image with Sum of Squared Difference (SSD), or Sum of Absolute Difference (SAD). Such extraction of the composite image data and calculation of the correlation value are performed for each pixel of the composite image, and are performed on all areas of the composite image. The correlation value of a place where data similar to the icon image data exists is smaller than the correlation values of other places in comparison. Such a correlation value is obtained by a known method (for example, https://algorithm.joho.info/image-processing/template-matching-sad-ssd-ncc/ or http://compsci.world.coocan.jp/OUJ/2012PR/pr_12_a.pdf). The index calculation unit 12 calculates the matching coefficient, which is an index representing the ease of recognition the icon image in the composite image, such that the matching coefficient becomes greater as the correlation value is smaller. That is, the greater the matching coefficient, the easier it is to recognize the icon image in the composite image.

The display position determination unit 13 determines the display position of the icon image on the combiner 3 based on the matching coefficient that is the index calculated by the index calculation unit 12. The graphic memory 22 stores the display position of icon image in the combiner 3 determined by the display position determination unit 13 and the icon image in association with each other.

The video signal generation unit 23 converts information stored in the graphic memory 22 into a video signal. The video signal generated by the video signal generation unit 23 is output to the projector 2. The projector 2 projects an icon image at the display position determined by the display position determination unit 13 in the combiner 3 in accordance with the video signal. In the combiner 3, the icon image is displayed at the display position determined by the display position determination unit 13.

The vehicle signal detection unit 24 detects a vehicle signal including an ON or OFF signal of the vehicle ACC power supply or an ON or OFF signal of the vehicle ignition power supply via a signal line 27. The signal line 27 is a signal line for transmitting the state of the vehicle, and includes a Controller Area Network (CAN) bus, or the like. The power supply 25 is a power supply for the display control apparatus 14, and turns on the display control apparatus 14 when the vehicle signal detection unit 24 detects the ACC power supply ON or the ignition power supply ON.

The time measurement unit 26 outputs time information to the pattern matching unit 21 in order to measure timing for performing pattern matching by the pattern matching unit 21 described later.

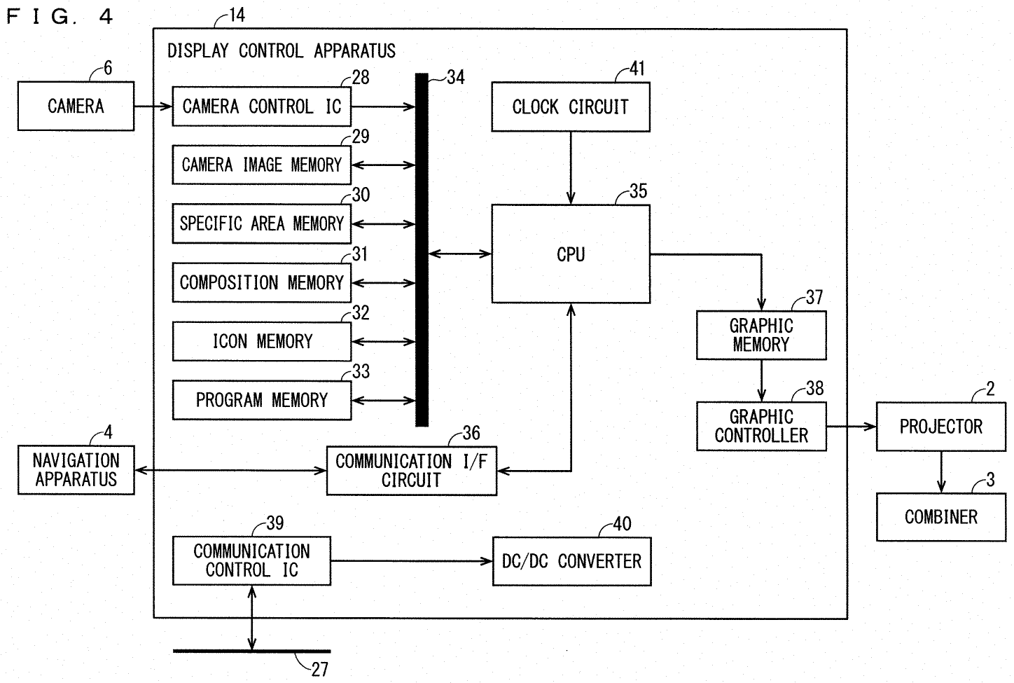

FIG. 4 is a block diagram illustrating an example of a hardware configuration of the display control apparatus 14.

As illustrated in FIG. 4, the display control apparatus 14 includes a camera control integrated circuit (IC) 28, a camera image memory 29, a specific area memory 30, a composition memory 31, an icon memory 32, a program memory 33, a Central Processing Unit (CPU) 35, a communication Interface (I/F) circuit 36, a graphic memory 37, a graphic controller 38, a communication control IC 39, a DC/DC converter 40, and clock circuit 41. The CPU 35, the camera control IC 28, the camera image memory 29, the specific area memory 30, the composition memory 31, the icon memory 32, and the program memory 33 are connected via a bus 34.

The camera control IC 28 acquires a camera image from the camera 6 in accordance with instruction from the CPU 35. The communication I/F circuit 36 communicates with the navigation device 4 in accordance with instruction from the CPU 35. The graphic controller 38 corresponds to the video signal generation unit 23 illustrated in FIG. 3.

The communication control IC 39 has a function of the vehicle signal detection unit 24 illustrated in FIG. 3, includes a communication I/F circuit, and is a CAN transceiver, for example. The DC/DC converter 40 has the power supply 25 illustrated in FIG. 3. The clock circuit 41 is provided for performing the time count, which is a function of the time measurement unit 26 illustrated in FIG. 3, and for the CPU 35 to control communication timing with each memory.

The camera image memory 29 corresponds to the camera image storage 15 illustrated in FIG. 3. The specific area memory 30 corresponds to the specific area storage 17. The composition memory 31 corresponds to the composition storage 20. The icon memory 32 corresponds to the icon storage 19.

Each function of the camera image acquisition unit 10, the specific area extraction unit 16, the icon acquisition unit 18, the composition unit 11, the index calculation unit 12, and the display position determination unit 13 in the display control apparatus 14 illustrated in FIG. 3 is realized by a processing circuit. That is, the display control apparatus 14 includes the processing circuit that acquires a camera image, extracts a specific area, acquires an icon image, composes the specific area with the icon image, calculates an index, and determines a display position. The processing circuit is a CPU 35 that executes a program stored in the program memory 33.

Each function of the camera image acquisition unit 10, the specific area extraction unit 16, the icon acquisition unit 18, the composition unit 11, the index calculation unit 12, and the display position determination unit 13 in the display control apparatus 14 illustrated in FIG. 3 is realized by software, firmware, or a combination of software and firmware. Software or firmware is described as a program and stored in the program memory 33. The CPU 35 reads out and executes the program stored in the program memory 33, thereby realizing the function of each unit. That is, the display control apparatus 14 includes the program memory 33 for storing the programs in which, eventually, execute a step of acquiring the camera image, a step of extracting the specific area, a step of acquiring the icon image, a step of composing the specific area with the icon image, a step of calculating the index, and a step of determining the display position. Further, these programs can also be said to cause a computer to execute procedures or methods of the camera image acquisition unit 10, the specific area extraction unit 16, the icon acquisition unit 18, the composition unit 11, the index calculation unit 12, and the display position determination unit 13. Here, a nonvolatile or volatile semiconductor memory such as a Random Access Memory (RAM), a Read Only Memory (ROM), a flash memory, an Erasable Programmable Read Only Memory (EPROM), an Electrically Erasable Programmable Read Only Memory (EEPROM), and the like, a magnetic disk, a flexible disk, an optical disk, a compact disk, a minidisk, a Digital Versatile Disk (DVD), or any storage media used in the future may be applied to the program memory 33.

<Operation>

<Overall Operation>

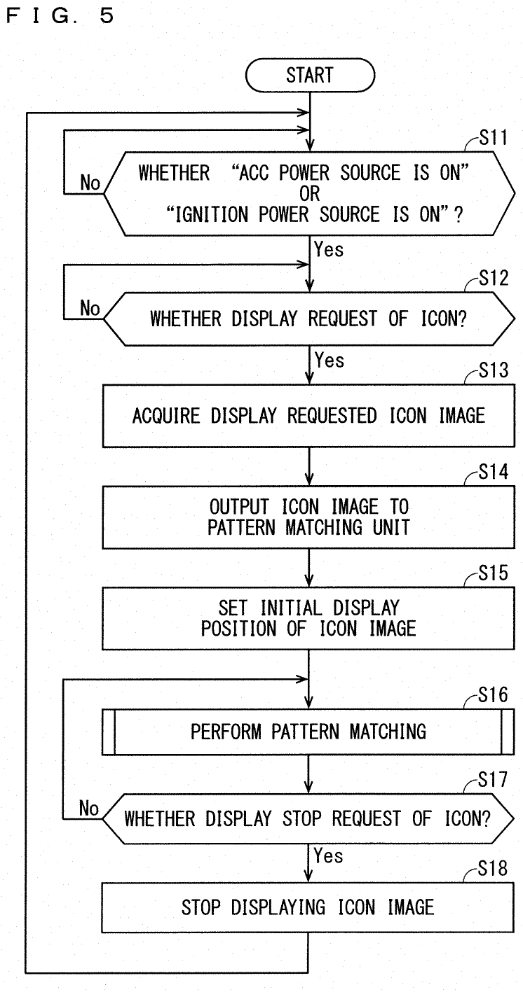

FIG. 5 is a flowchart illustrating an example of overall operation of the display control apparatus 14.

In Step S11, the vehicle signal detection unit 24 detects the vehicle signal and determines whether the ACC power source is ON or the ignition power source is ON. The process of Step S11 is repeated until it is detected that the ACC power supply is ON or the ignition power supply is ON. When detected that the ACC power supply is ON or the ignition power supply is ON, the process proceeds to Step S12. When the vehicle signal detection unit 24 detects that the ACC power supply is ON or the ignition power supply is ON, the power supply 25 turns on the display control apparatus 14. Accordingly, the display control apparatus 14 executes the following processes.

In Step S12, the icon acquisition unit 18 determines whether a request for displaying an icon image on the combiner 3 has been acquired from the navigation device 4. The process of Step S12 is repeated until the request for displaying an icon image on the combiner 3 is acquired from the navigation device 4, and when the request for displaying an icon image on the combiner 3 has been acquired from the navigation device 4, the process proceeds to Step S13.

In Step S13, the icon acquisition unit 18 acquires an icon image responding to the request from the navigation device 4 from the icon storage 19. In Step S14, the icon acquisition unit 18 outputs the icon image acquired from the icon storage 19 to the pattern matching unit 21.

In Step S15, the pattern matching unit 21 sets an initial display position of the icon image. In Step S16, the pattern matching unit 21 performs pattern matching.

In Step S17, the icon acquisition unit 18 determines whether a request to stop displaying an icon image on the combiner 3 has been acquired from the navigation device 4. When the request to stop displaying the icon image on the combiner 3 has been acquired from the navigation device 4, the process proceeds to Step S18. Meanwhile, when the request to stop displaying the icon image on the combiner 3 has not been acquired from the navigation device 4, the process returns to Step S16.

In Step S18, the pattern matching unit 21 stops displaying the icon image on the combiner 3. Thereafter, the process returns to Step S11.

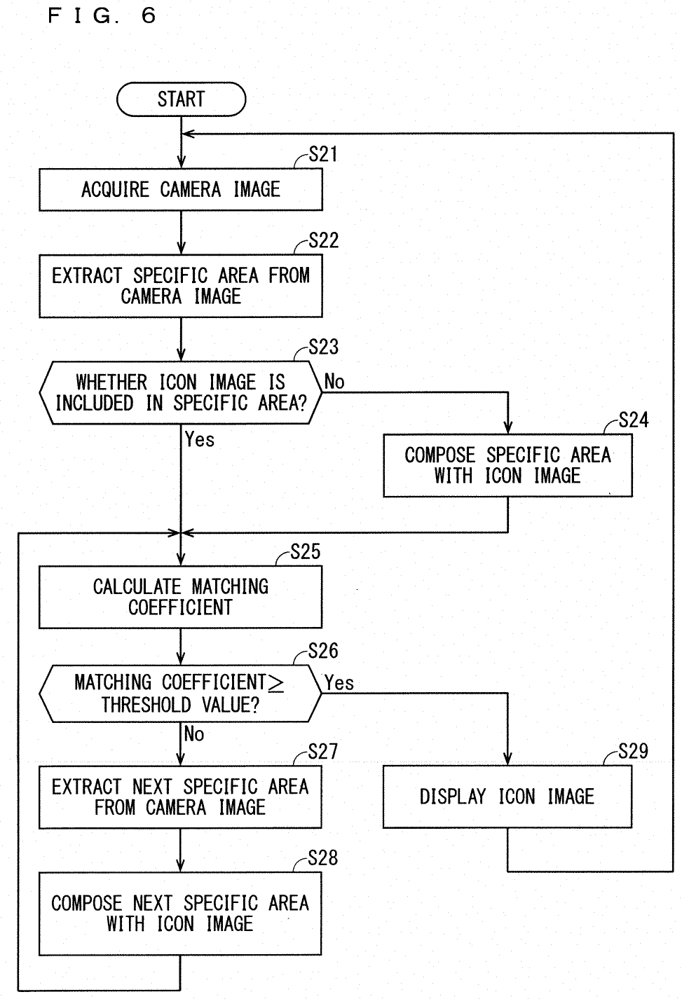

FIG. 6 is a flowchart illustrating an example of operation of the display control apparatus 14, and illustrates the detailed operation of Step S16 in FIG. 5. The operation of the display control apparatus 14 illustrated in FIG. 6 is roughly divided into operation when the icon image is displayed first on the combiner 3 and operation when the icon image is already displayed on the combiner 3. Hereinafter, these operations will be described in order.

<Operation when Icon Image is Displayed First on Combiner 3>

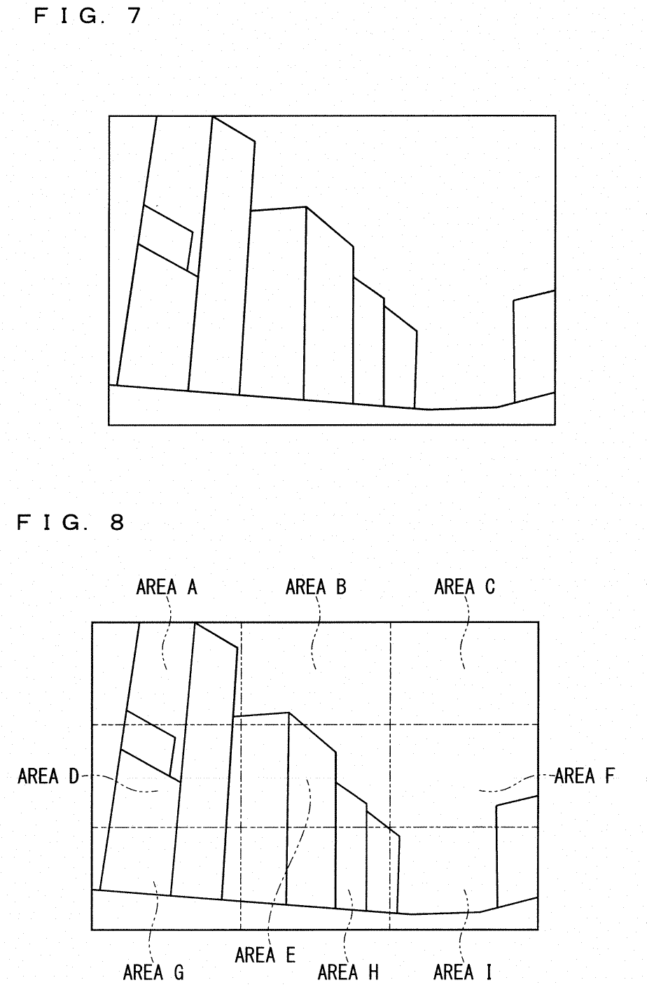

In Step S21, the camera image acquisition unit 10 acquires a camera image including the entirety of the combiner 3 captured by the camera 6. The camera image acquisition unit 10 stores the acquired camera image in the camera image storage 15. FIG. 7 is a diagram illustrating an example of a camera image acquired by the camera image acquisition unit 10. The camera image illustrated in FIG. 7 corresponds to the entire combiner 3.

In Step S22, the specific area extraction unit 16 divides the camera image stored in the camera image storage 15 into a plurality of areas, and extracts a specific area that is one of the plurality of divided areas. The specific area extraction unit 16 stores the extracted specific area in the specific area storage 17.

FIG. 8 is a diagram illustrating an example of division of the camera image. In the example of FIG. 8, the specific area extraction unit 16 divides the camera image into nine areas A to I, and extracts an area A as the specific area.

In Step S23, the composition unit 11 refers to the specific area stored in the specific area storage 17, and determines whether or not an icon image is included in the specific area. At this time, the composition unit 11 has received information on the initial display position of the icon image set by the pattern matching unit 21 in Step S15 in FIG. 5 from the pattern matching unit 21, and determines whether or not an icon image is included in the specific area based on the initial display position. As a result, “the operation when an icon image is displayed first on the combiner 3” is a case where there is no icon image on the combiner 3, and in this case, the process of Step S23 is always “No”. Here, the initial display position of the icon image is assumed to be the area A.

When no icon image is included in the specific area, that is, when the process in Step S23 is “No”, the process proceeds to Step S24. In the example of FIG. 8, the icon image is not included in the area A, that is the specific area; therefore, the process proceeds to Step S24.

In Step S24, the composition unit 11 composes the specific area stored in the specific area storage 17 with the icon image received from the pattern matching unit 21. The composition unit 11 outputs the composite image obtained by composing the specific area with the icon image to the pattern matching unit 21.

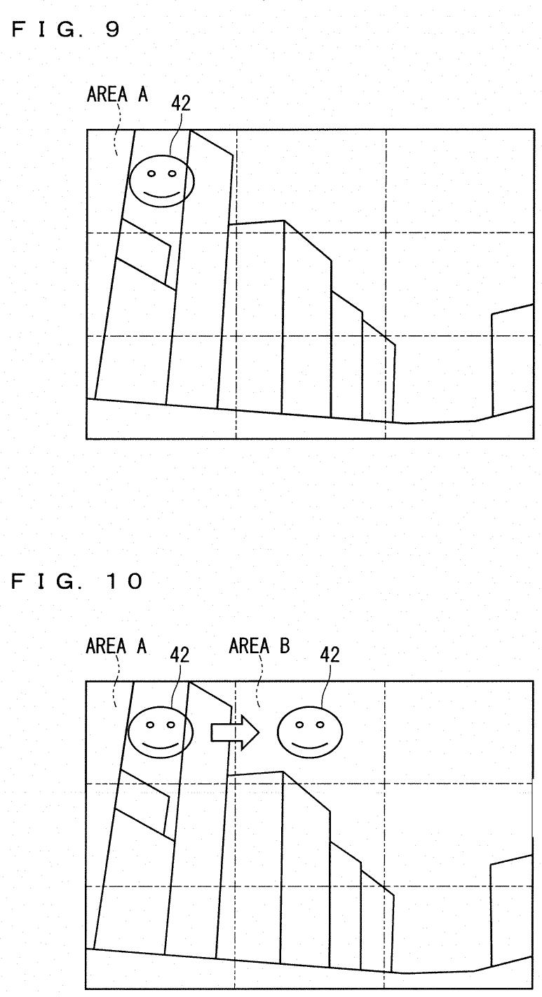

FIG. 9 is a diagram illustrating an example of the composite image. In the example of FIG. 9, the area A, that is a specific area, is composed with the icon image 42. In FIG. 9, other areas B to I are also illustrated for convenience of explanation.

In Step S25, the index calculation unit 12 calculates a matching coefficient that is an index representing the ease of recognizing an icon image in the composite image generated by the composition unit 11. The method of calculating the matching coefficient is as described above.

In Step S26, the pattern matching unit 21 determines whether or not the matching coefficient calculated by the index calculation unit 12 is equal to or greater than a threshold value. When the matching coefficient is equal to or greater than the threshold value, the process proceeds to Step S29. Meanwhile, when the matching coefficient is not equal to or greater than the threshold value, that is, the matching coefficient is smaller than the threshold value, the process proceeds to Step S27.

In the example of FIG. 9, the icon image 42 is superimposed on a building included in the area A, that is a specific area, therefore it is hard to be seen. In this case, the matching coefficient calculated by the index calculation unit 12 is smaller than the threshold value; therefore, the process proceeds to Step S27.

In Step S27, the pattern matching unit 21 instructs the specific area extraction unit 16 to extract the next specific area. The instruction includes instruction on which area in the divided camera image is to be extracted. Here, the pattern matching unit 21 instructs to extract specific areas in the order of areas A to I.

The specific area extraction unit 16 extracts the next specific area from the camera image stored in the camera image storage 15 in accordance with the instruction from the pattern matching unit 21. Here, the specific area extraction unit 16 extracts the area B as the next specific area, and stores the extracted area B in the specific area storage 17.

In Step S28, the composition unit 11 composes the area B, that is the specific area, stored in the specific area storage 17 with the icon image received from the pattern matching unit 21. The composition unit 11 outputs the composite image obtained by composing the area B, that is the specific area, with the icon image to the pattern matching unit 21.

FIG. 10 is a diagram illustrating an example of the composite image. In the example of FIG. 10, the area B, that is a specific area, is composed with the icon image 42. Note that in FIG. 10, for convenience of explanation, the other area A and areas C to I are also illustrated, and illustrates that the display position of the icon image 42 is changed from the area A to the area B.

Following Step S28, the process proceeds to Step S25, and the processes of Step S25 and Step S26 are performed. Steps S25 to S28 are repeated until the pattern matching unit 21 determines that the matching coefficient is equal to or greater than the threshold value in step S26. And when the pattern matching unit 21 determines that the matching coefficient is equal to or greater than the threshold value in Step S26, the process proceeds to Step S29.

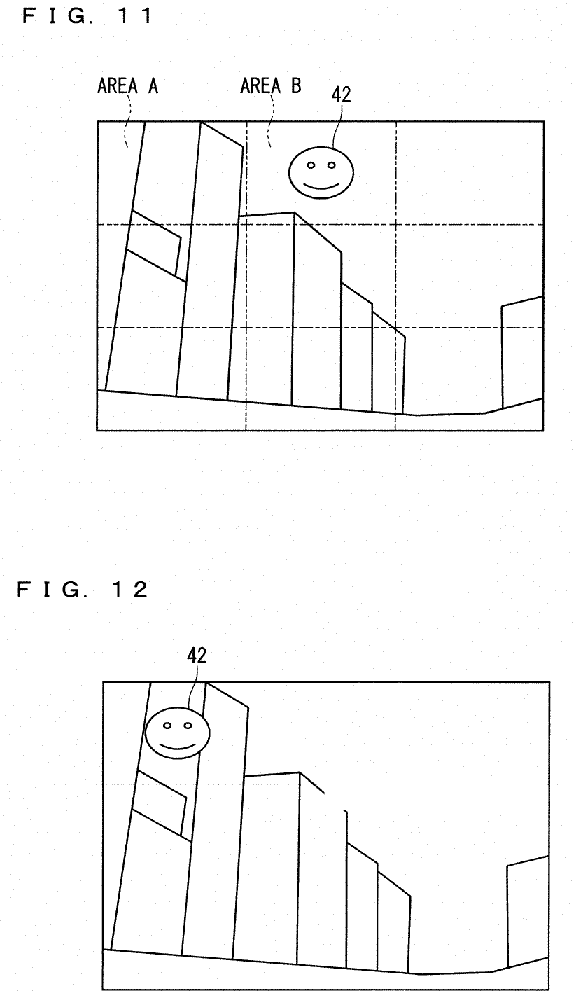

In Step S29, the display position determination unit 13 determines the display position of the icon image on the combiner 3 based on the matching coefficient that is the index calculated by the index calculation unit 12. Specifically, the display position determination unit 13 sets an area in which the matching coefficient calculated by the index calculation unit 12 is equal to or greater than the threshold value, as the display position of the icon image. The graphic memory 22 stores the display position of the icon image in the combiner 3 determined by the display position determination unit 13 and the icon image in association with each other. The video signal generation unit 23 converts information stored in the graphic memory 22 into a video signal. The video signal generated by the video signal generation unit 23 is output to the projector 2. The projector 2 projects the icon image at the display position determined by the display position determination unit 13 in the combiner 3 in accordance with the video signal. In the combiner 3, the icon image is displayed at the display position determined by the display position determination unit 13. FIG. 11 is a diagram illustrating an example of an icon image displayed on the combiner 3.

In step S26, if the matching coefficient calculated by the index calculation unit 12 is equal to or greater than the threshold value in the area A, that is the specific area, it goes without saying that the process proceeds to Step S29 at that time and the process of Step S29 is performed.

The above operation is the operation when the icon image is displayed first on the combiner 3.

<Operation when Icon Image is Already Displayed on Combiner 3>

The processes in Step S22, Step S24, and Step S26 to Step S28 are the same as the processes described in the above “the operation when the icon image is displayed first on combiner 3”, and thus description thereof is omitted here. Hereinafter, Step S21, Step S23, and Step S25 will be described.

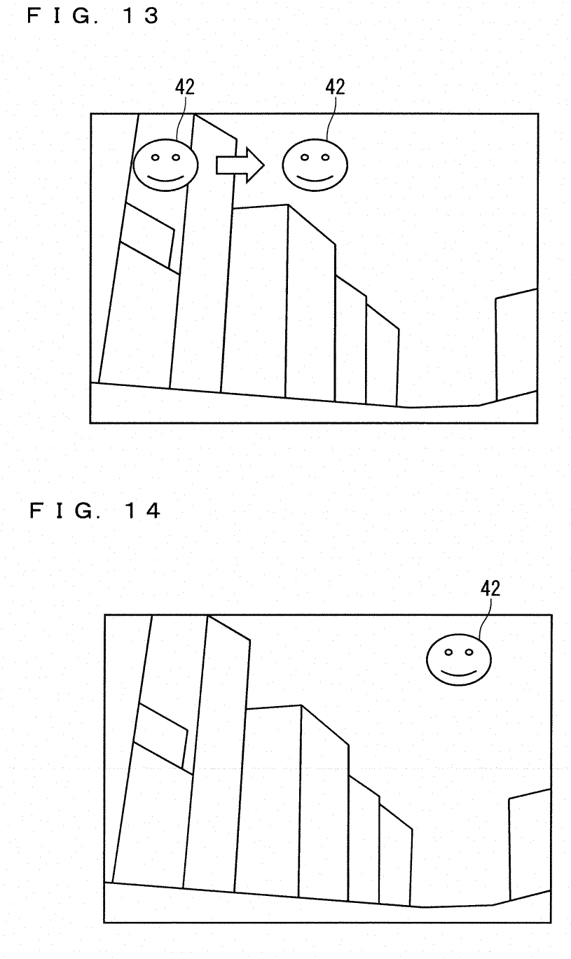

In Step S21, the camera image acquisition unit 10 acquires a camera image including the entirety of the combiner 3 captured by the camera 6. The camera image acquisition unit 10 stores the acquired camera image in the camera image storage 15. FIG. 12 is a diagram illustrating an example of a camera image acquired by the camera image acquisition unit 10. The camera image illustrated in FIG. 12 corresponds to the entire combiner 3. As illustrated in FIG. 12, the camera image includes an icon image 42 displayed on the combiner 3.

In Step S23, the composition unit 11 refers to the specific area stored in the specific area storage 17, and determines whether or not an icon image is included in the specific area. At this time, the composition unit 11 has received information on the initial display position of the icon image set by the pattern matching unit 21 in Step S15 in FIG. 5 from the pattern matching unit 21, and determines whether or not an icon image is included in the specific area based on the initial display position.

In the example of FIG. 12, for example, when the icon image 42 is displayed in the area A, that is the specific area, the composition unit 11 determines that the icon image 42 is included in the area A, that is the specific area, and the process proceeds to Step S25.

In Step S25, the index calculation unit 12 calculates a matching coefficient that is an index representing the ease of recognizing an icon image 42 in the area A, that is the specific area. The method of calculating the matching coefficient is as described above.

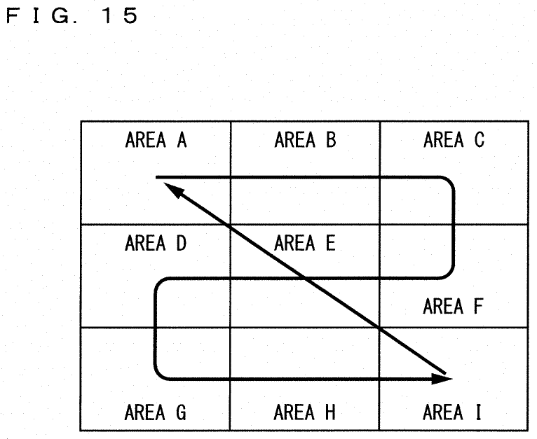

In the example of FIG. 12, the icon image 42 is superimposed on a building included in the area A, that is a specific area, therefore it is hard to be seen. In this case, the matching coefficient calculated by the index calculation unit 12 is smaller than the threshold value; therefore, the process proceeds to Step S27 and Step S28. Then, for example, as illustrated in FIG. 13, the icon image 42 is superimposed on the next specific area. And Steps S25 to S28 are repeated until the pattern matching unit 21 determines that the matching coefficient is equal to or greater than the threshold value in step S26. Then, when the pattern matching unit 21 determines that the matching coefficient is equal to or greater than the threshold value in step S26, the process proceeds to Step S29, and the icon image 42 is displayed in the area C of the combiner 3, for example, as illustrated in FIG. 14.

The above operation is the operation when the icon image is already displayed on the combiner 3.

### MODIFICATION

In the above description, the case where the icon image is displayed in the area where the matching coefficient becomes equal to or greater than the threshold value first has been described, however, the present invention is not limited thereto. For example, when the matching coefficients of all the areas are less than the threshold value in Step S26, the icon image may be displayed in the area with the highest matching coefficient, or the icon image may be displayed in a predetermined area. The predetermined area includes, for example, the upper right area of the combiner 3 when the icon image is an arrow, the upper left area of the combiner 3 when the icon image is not an arrow, and the central area of the combiner 3 when the icon image is of any image type.

In the above description, a case has been described in which the matching coefficients are sequentially calculated for a plurality of areas of a divided camera image, and an icon image is displayed in an area where the matching coefficient becomes equal to or greater than the threshold value first, however, the present invention is not limited thereto. There may be an area with a higher matching coefficient than the area where the matching coefficient has become equal to or greater than the threshold value first; therefore, the matching coefficients may be calculated for all areas, and then the icon image may be displayed in area with the highest matching coefficient that is equal to or greater than the threshold.

In the above description, the case where whether or not the matching coefficient is the predetermined threshold value or greater is determined has been described, however, the present invention is not limited thereto. For example, the icon image may be displayed in the area with the highest matching coefficient after calculating the matching coefficients for all areas without setting the threshold value. Further, the matching coefficient of the first area may be set as the threshold value. Furthermore, the matching coefficient of the area in which the last display position is determined may be used as the threshold value.

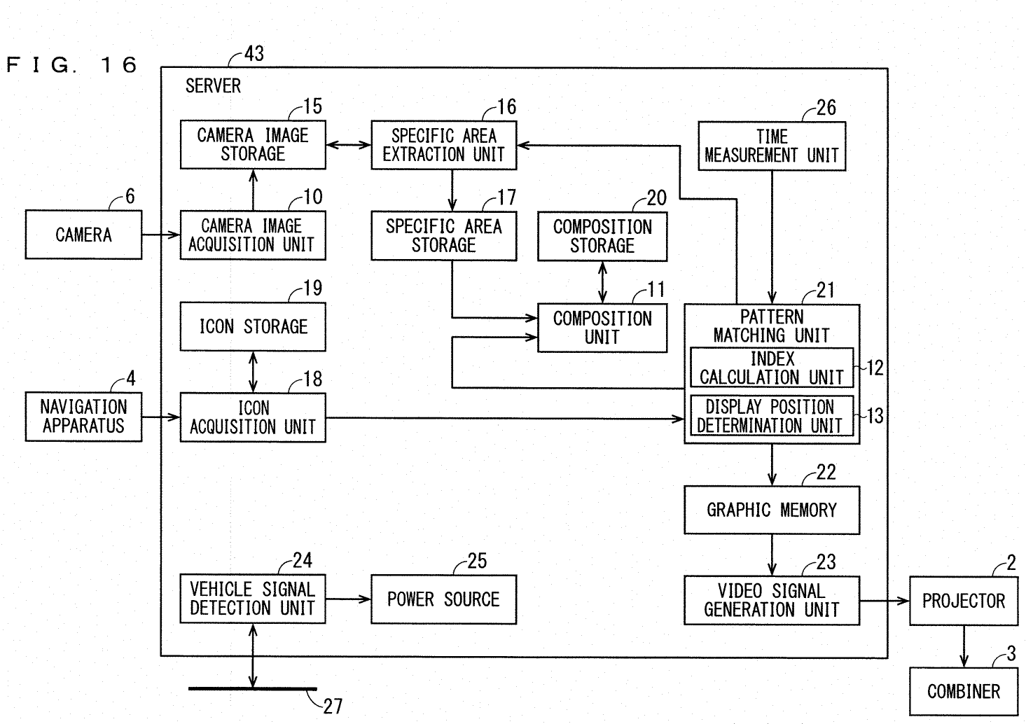

In the above description, the case where the matching coefficients are calculated in the order of areas A to I as illustrated in FIG. 15 for a plurality of areas of the divided camera image has been described, however, the present invention is not limited thereto. For example, in FIG. 15, the matching coefficients may be calculated in the order of areas A, D, G, B, E, H, C, F, and I. Alternatively, each area may be extracted at random, and a matching coefficient for the extracted area may be calculated.

In the above, the case where the camera image is divided into nine as illustrated in FIG. 8 has been described, the present invention is not limited thereto. The number of areas into which the camera image is divided may be plural.

In the above, the case where a shape of the divided area of the camera image is a rectangle as illustrated in FIG. 8 has been described, the present invention is not limited thereto. For example, a tetragon other than a rectangle, a triangle, a polygon, or a circle may be applicable.

From the above, according to Embodiment, the HUD combiner displays an icon image in an area with a high matching coefficient, which is an index representing the ease of visual recognition of the icon image. Accordingly, the icon image is displayed at a position with ease of visual recognition for the driver, the driver can surely obtain necessary information. That is, the visibility of information displayed on the HUD combiner can be improved.

In Embodiment, the case where the icon image is displayed on the combiner has been described, however, the present invention is not limited thereto. For example, the Embodiment can be applied even when the HUD is configured to display an icon image on the windshield instead of the combiner.

In Embodiment, the case where an icon image is displayed on the HUD has been described, however, the present invention is not limited thereto. For example, Embodiment can be applied to a back monitor that displays a camera image obtained by capturing the rear of the vehicle. The Embodiment can also be applied to a head mounted display.

The display control apparatus described above is applicable not only to an on-vehicle navigation apparatus, that is a satellite navigation apparatus, but a navigation apparatus or devices other than navigation apparatuses constructed as a system by appropriately combining a Portable Navigation Device (PND) that can be mounted on a vehicle and a server provided outside the vehicle. In this case, each function or each component of the display control apparatus is distributed and arranged in each function for constructing the above system.

Specifically, as an example, the function of the display control apparatus can be arranged in a server. For example, as illustrated in FIG. 16, the user side includes the projector 2, the combiner 3, the navigation device 4, and the camera 6. A server 43 includes the camera image acquisition unit 10, the composition unit 11, the index calculation unit 12, the display position determination unit 13, the camera image storage 15, the specific area extraction unit 16, the specific area storage 17, the icon acquisition unit 18, the icon storage 19, the composition storage 20, the pattern matching unit 21, the graphic memory 22, the video signal generation unit 23, the vehicle signal detection unit 24, the power supply 25, and the time measurement unit 26. With such a configuration, a display control system can be constructed.

As described above, even if each function of the display control apparatus is distributed and arranged in each function for constructing the system, the same effect as in above Embodiment can be obtained.

In addition, software that executes the operations in above-described Embodiment may be incorporated in a server, for example. The method of display control realized by the server executing this software allows to acquire a camera image that is an image captured by the camera, generate a composite image by composing a specific area obtained by dividing the acquired camera image with a predetermined icon image, calculate an index representing the ease of recognition of the icon image in the generated composite image, and determine a display position of the icon image based on the calculated index.

As described above, by incorporating the software for executing the operations in above-described Embodiment into the server and operating it, the same effect as in above-described Embodiment can be obtained.

It should be noted that Embodiment of the present invention can be appropriately modified or omitted without departing from the scope of the invention.

While the invention has been described in detail, the forgoing description is in all aspects illustrative and not restrictive. It is understood that numerous other modifications and variations can be devised without departing from the scope of the invention.

### EXPLANATION OF REFERENCE SIGNS

1 display control apparatus, 2 projector, 3 combiner, 4 navigation apparatus, 5 driver, 6 camera, 7 windshield, 8 roof, 9, display control apparatus, camera image acquisition unit, 11 composition unit, 12 index calculation unit, 13 display position determination unit, 14 display control apparatus, 15 camera image storage, 16 specific area extraction unit, 17 specific area storage, 18 icon acquisition unit, 19 icon storage, 20 composition storage, 21 pattern matching unit, 22 graphic memory, 23 video signal generation unit, 24 vehicle signal detection unit, 25 power source, 26 time measurement unit, 27 signal line, 28 camera control IC, 29 camera image memory, 30 specific area memory, 31 composition memory, 32 icon memory, program memory, 34 bus, 35 CPU, 36 communication I/F circuit, 37 graphic memory, 38 graphic controller, 39 communication control IC, 40 DC/DC converter, 41 clock circuit, 42 icon image, 43 server.

1. A display control apparatus comprising:
a processor to execute a program; and
a memory to store the program which, when executed by the processor, performs processes of,
acquiring a camera image that is an image captured by a camera;
generating a composite image by composing one area among a plurality of areas obtained by dividing the acquired camera image with a predetermined icon image;
calculating an index representing ease of recognition of the icon image in the generated composite image; and
determining a display position of the icon image based on the calculated index.

2. The display control apparatus according to claim 1, wherein
the calculating process comprises sequentially calculating the index of each of the areas, and
the determining process comprises determining, as the display position, the area in which the index becomes equal to or greater than a predetermined threshold value first.

3. The display control apparatus according to claim 1, wherein
the calculating process comprises calculating the index of each of all the areas, and
the determining process comprises determining, as the display position, the area with the highest index, when a plurality of the areas with the index that is equal to or greater than a threshold value exist.

4. The display control apparatus according to claim 1, wherein
the calculating process comprises calculating the index of each of all of the areas, and
the determining process comprises determining a predetermined position as the display position when the index of each of all of the areas is smaller than the predetermined threshold.

5. The display control apparatus according to claim 1, wherein
the calculating process comprises sequentially calculating the index of each of the areas, and
with the index of the area first calculated by the index calculation unit as the threshold value, the determining process comprises determining, as the displayed position, the area of which index is equal to or greater than the threshold value.

6. The display control apparatus according to claim 1, wherein
the calculating process comprises calculating the index of each of all of the areas, and
the determining process comprises determining, as the display position, the area with the highest index among all of the areas.

7. The display control apparatus according to claim 1, wherein
the determining process uses the index of the area determined as the last display position as the threshold value.

8. A method of display control comprising the steps of:
acquiring a camera image that is an image captured by a camera;
generating a composite image by composing a specific area obtained by dividing the acquired camera image with a predetermined icon image;
calculating an index representing ease of recognition of the icon image in the generated composite image; and
determining a display position of the icon image based on the calculated index.
